(19) United States
(12) Patent Application Publication
(10) Pub. No.: US 2012/0279362 A1
(43) Pub. Date: Nov. 8, 2012

(54) Powered Bolt-Through Tourque Wrench

(75) Inventors: David Cummings, Princeton, MA (US); Derek Silsby, Worcester, MA (US); Paul Carnes, North Dartmouth, MA (US)

(73) Assignee: Lowell Corporation, West Boylston, MA (US)

(21) Appl. No.: 13/461,132

(22) Filed: May 1, 2012

Related U.S. Application Data
(60) Provisional application No. 61/483,129, filed on May 6, 2011.

(51) Int. Cl. B25B 21/00

(52) U.S. Cl. 81/57.11; 81/54

(57) ABSTRACT

A torque wrench assembly includes a housing having a motor assembly and a socket defining an opening extending along a longitudinal axis from a first end to a second end and having at least one fastener driving portion disposed at one of the first end and the second end of the socket. The torque wrench assembly includes a socket drive interface coupled to the housing and disposed in operative communication with the motor assembly and with the socket.

### RELATED APPLICATIONS

This patent application claims the benefit of U.S. Provisional Patent Application No. 61/483,129 filed on May 6, 2011, entitled “Battery Powered Bolt-Through Socket Wrench,” the contents and teachings of which are hereby incorporated by reference in their entirety.

### BACKGROUND

A conventional ratchet wrench or socket driver is configured to tighten or loosen fasteners, such as nuts or bolts, with a series of sequential backward and forward rotations. Conventional socket drivers can be configured as electrically powered devices. For example, certain electrically powered socket drivers can be connected to a source of electricity, such as an AC power source, by an electrical cable. Additionally, cordless electric socket drivers typically include a DC electric motor powered by a battery, which is typically either built into the tool or configured as a removeable battery pack.

### SUMMARY

Conventional powered socket drivers suffer from a variety of deficiencies. For example conventional powered socket driver tools include a motor assembly that drives a socket attachment portion carried by the tool. The socket attachment portion is typically configured as a square or hex shaped male attachment portion having a ball detent. The male attachment portion is configured to couple to a corresponding socket receptacle of socket. Using the attachment portion, a user can attach and remove a variety of differently sized sockets (e.g., ⅜″, ¾″, ½″, etc.) relative to the tool. With such a configuration, however, the conventional powered socket driver is unable to provide bolt-though capabilities. Specifically, the socket attachment portion and attached socket blocks or prevents a bolt shaft from extending through the powered socket driver tool.

By contrast to conventional powered socket drivers, embodiments of the present innovation relate to a powered bolt-through torque or socket wrench. For example, the powered bolt-through socket wrench includes a distal or working end that defines a through-opening configured to accept bolt-through sockets, such double ended sockets that can accept fasteners, such as hex nuts, of two different sizes. The bolt-through sockets can be used to move nuts along threaded shafts that extend through the socket. The powered bolt-through torque wrench includes a motor assembly configured to drive the bolt-through in either a clockwise or counterclockwise direction.

In one arrangement, a torque wrench assembly includes a housing having a motor assembly and a socket defining an opening extending along a longitudinal axis from a first end to a second end and having at least one fastener driving portion disposed at one of the first end and the second end of the socket. The torque wrench assembly includes a socket drive interface coupled to the housing and disposed in operative communication with the motor assembly and with the socket.

In one arrangement, a torque wrench assembly includes a housing having a motor assembly and a battery disposed in electrical communication with the motor assembly and a socket housing coupled to the housing. The socket housing includes a socket coupled to the socket housing, the socket defining an opening extending along a longitudinal axis from a first end to a second end and having at least one fastener driving portion disposed at one of the first end and the second end of the socket. The socket housing includes a socket drive interface coupled to the socket housing, the socket drive interface disposed in operative communication with the motor assembly and with the socket.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 is a schematic representation of a side, and partial sectional, view of a torque wrench assembly, according to one arrangement.

FIG. 2 illustrates a top view of the torque wrench assembly of FIG. 1, according to one arrangement.

FIG. 3 illustrates a bottom view of the torque wrench assembly of FIG. 1, according to one arrangement.

FIG. 4 illustrates a perspective sectional view of a socket, according to one arrangement.

FIG. 5 illustrates a perspective sectional view of a socket, according to one arrangement.

FIG. 6 illustrates a bolt disposed through an opening of a socket of the torque wrench assembly of FIG. 1, according to one arrangement.

FIG. 7 is a schematic representation of a side view of a torque wrench assembly having a handle, according to one arrangement.

FIG. 8 illustrates a top view of the torque wrench assembly of FIG. 7, according to one arrangement.

FIG. 9 is a schematic representation of a side view of a torque wrench assembly having a handle, according to one arrangement.

FIG. 10 is a schematic representation of a side view of a torque wrench assembly having a handle, according to one arrangement.

### DETAILED DESCRIPTION

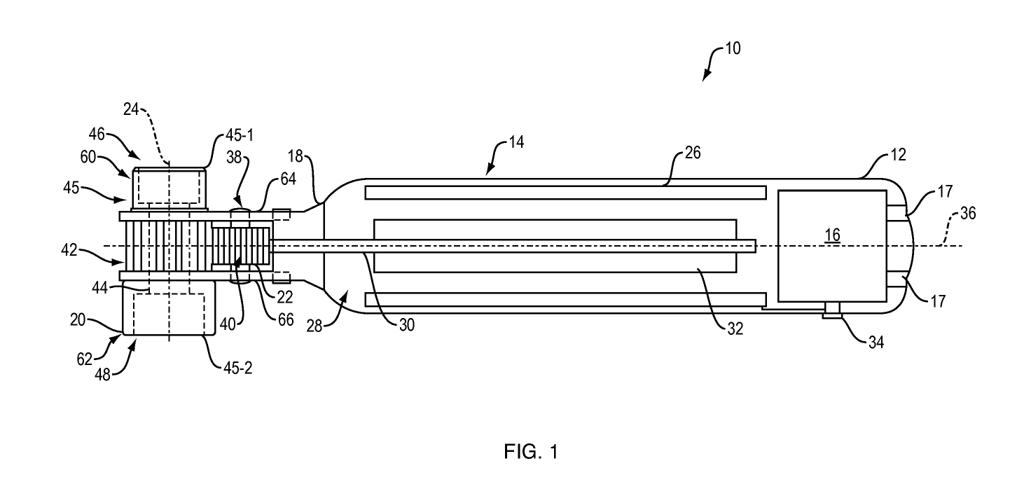

FIG. 1 illustrates a driver or torque wrench assembly 10, such as used in the water works industry, according to one arrangement. The torque wrench assembly 10 includes a housing 12 having a motor assembly 14 and a battery 16 disposed in electrical communication with the motor assembly 14. The torque wrench assembly 10 also includes a socket housing 18 that carries a socket 20 and a socket drive interface 22 disposed in operable communication between the socket 20 and the motor assembly 14.

The motor assembly 14 is configured to drive the socket drive interface 22 to rotate the corresponding socket 20 either clockwise or counterclockwise about a longitudinal axis 24. For example the motor assembly 14 includes a stator 26, having a coil and backing ferromagnetic material, and a rotor assembly 28 that includes a rotor shaft 30 having a set of magnets 32 disposed about an outer periphery.

The battery 16 is configured to provide current to the motor assembly 14 to rotate the socket 20. In one arrangement, the battery 16 is disposed in electrical communication with a switch 34, such as a user-operable switch, configured to selectively complete an electrical circuit with the motor assembly 14. During operation, as a user activates the switch 34, the switch 34 electrically couples the battery 16 to the motor assembly 14. The battery 16, in turn, supplies current to coils of the stator 26 which causes the shaft 30 to rotate about a longitudinal axis 36 of the housing 12 to rotate the socket drive interface 22 relative to the socket housing 18.

The battery 16 can be configured in a variety of ways. In one arrangement, the battery 16 is configured as being removeable from the housing 12. For example, when the battery 16 becomes discharged after a given duration of use, a user can remove the battery 16 from the housing and replace it with a fully-charged battery 16. In another arrangement, the battery 16 is configured as a rechargeable battery. In such an arrangement, when the battery 16 becomes discharged, a user can connect the battery 16 to an external charging device via contacts 17 to recharge the battery 16.

The socket drive interface 22 is configured to rotate the socket 20 about the longitudinal axis 24 in response to rotation of a rotor 30 of the motor assembly 14. For example, the socket drive interface 22 is configured as a gear element, such as a worm gear, rotatably coupled to the socket housing 18 via an axle 38. The teeth 40 of the gear element 22 mesh with corresponding teeth 42 of the socket 20. In use, as the motor assembly 14 rotates the socket drive interface 22 about the axel 38, such as along a clockwise direction, the socket drive interface 22 rotates the socket 20 about the longitudinal axis 24, such as along a counterclockwise direction.

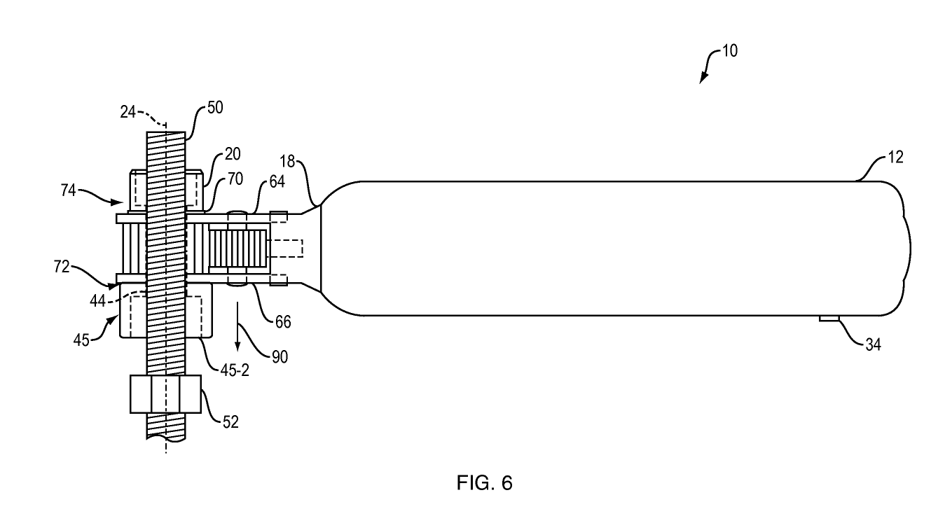

The socket 20, in one arrangement, is a bolt-through socket having opposing fastener driving portions 45 disposed at either end of the socket 20. For example, the socket 20 is configured as a generally cylindrical structure defining an opening 44 extending along the longitudinal axis 24 from a first end 46 to a second end 48, there through. With such a configuration, a user can utilize the bolt-through socket 20 to move a fastener, such as a nut, along a threaded shaft where the shaft extends through the opening 44 of the socket 20. For example, with reference to FIG. 6, the socket 20 can be disposed about an elongate structure 50, such as a threaded shaft or bolt, with the elongate structure 50 extending through the opening 44. The socket 20, accordingly, provides an associated fastener driving portion 45 with access to a fastener 52 disposed at a far end of the structure 50.

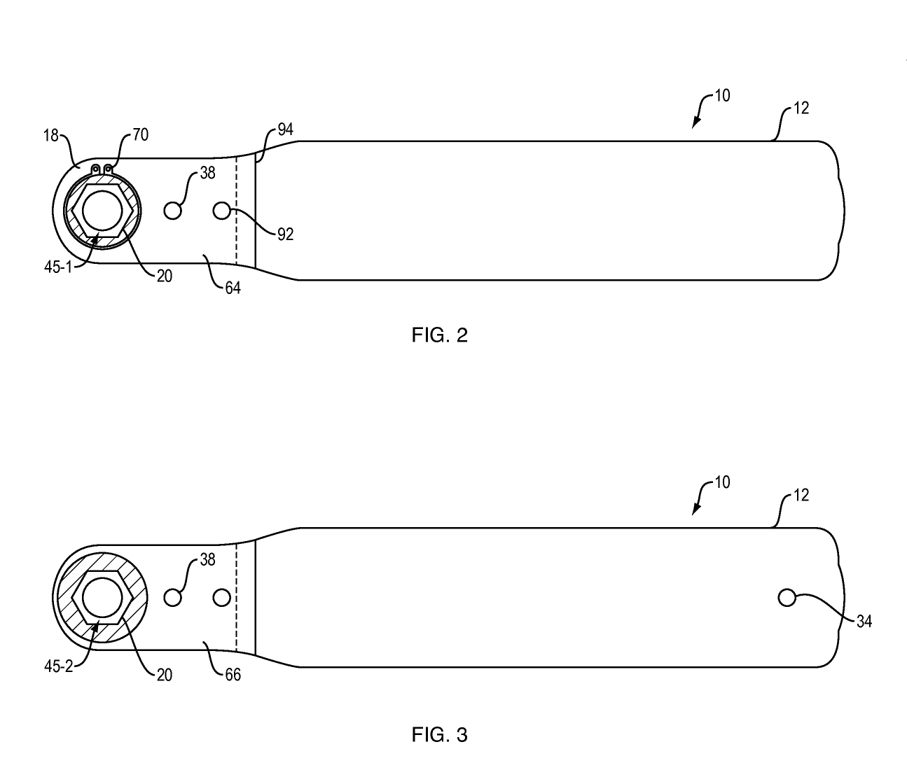

The fastener driving portions 45 are disposed within an inner periphery of the socket 20 at opposing ends 46, 48 of the socket. For example, with additional reference to FIGS. 2 and 3, the socket 20 includes a first fastener driving portion 45-1 disposed at a first end 46 and a second fastener driving portion 45-2 disposed at a second end 48. While the fastener driving portions 45 can be configured in a variety of ways, in one arrangement, the fastener driving portions 45 are configured as hex drive structures having six point hexes or twelve point hexes, for example. In another arrangement, fastener driving portions 45 are configured as square drive or star-shaped openings that accept more than one fastener size.

The fastener driving portions 45 of the socket 20 are configured to actuate two differently-sized fasteners. For example, the fastener driving portion 45-1 can be configured to drive a fastener, such as nut or bolt head, having a first size, such as a size of 1.25 (1-¼) Hex. The fastener driving portion 45-2 can be configured to drive a fastener, such as nut or bolt head, and having a second size, such as a size of 1.125 (1-⅛) Hex. Accordingly, the torque wrench assembly 10 provides a two-in-one fastener driving capability.

Returning to FIG. 1, in one arrangement, fastener driving portions 45 are disposed within hub extension portions of the socket 20. For example, the socket 20 includes a first hub extension portion 60 extending through a socket housing opening and from a first face 64 of the socket housing 18 and second extension portion 62 extending through the socket housing opening and from second face 66 of the socket housing 18. Each extension portion 60, 62 is configured to provide adequate contact between the socket hub 20 the target fastener 52 to minimize slipping between the torque wrench assembly 10 and fastener 52 during operation.

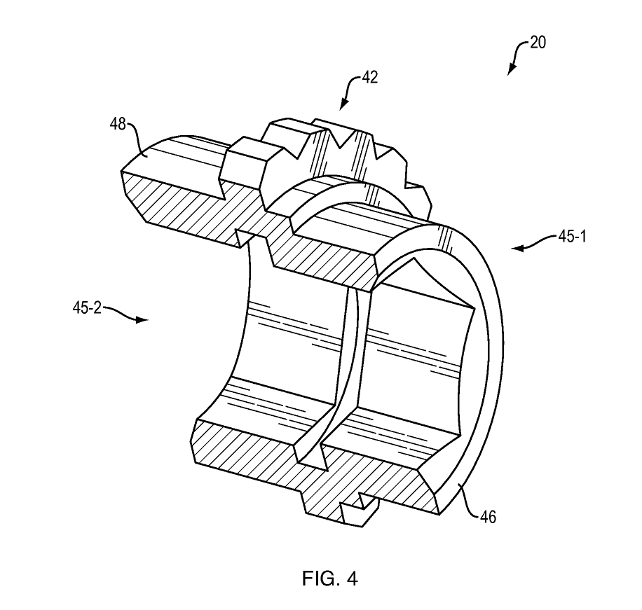

As indicated above, with reference to FIG. 1, the socket 20 includes a set of teeth 42 disposed about an outer periphery of the cylinder structure. While the teeth 42 can be configured in a variety of ways, in the arrangement illustrated in FIG. 4, the teeth 42 are configured as external teeth (i.e., as a gear) where the outer tooth diameter of each of the teeth is greater than either of the outside diameters of either end 46, 48 of the socket 20. In another arrangement, as illustrated in FIG. 6, the teeth 42 are configured as internal teeth as part of the socket hub 20 where the outer tooth diameter of each of the teeth is less than or equal to the outside diameters of both ends 46, 48 of the socket 20. In one arrangement, the outer diameter of the teeth 42 is equal to one outside end diameter allowing for the socket 20 to be inserted into an opening extending through the socket housing 18 allowing for the teeth 42 of the socket 20 to pass through the socket housing opening, thereby providing ease of assembly. Additionally, while the set of teeth 42 can include any number of teeth, in one arrangement, the set of teeth 42 include between about 20 teeth and 50 teeth to minimize backlash with the socket drive interface 22 during operation.

The socket 20 can be secured to the socket housing 18 in a variety of ways. In one arrangement, the geometry of the socket 20 in conjunction with a fastener 70, such as a snap ring as illustrated in FIG. 2, provides rotatable attachment of the socket 20 to the socket housing 18.

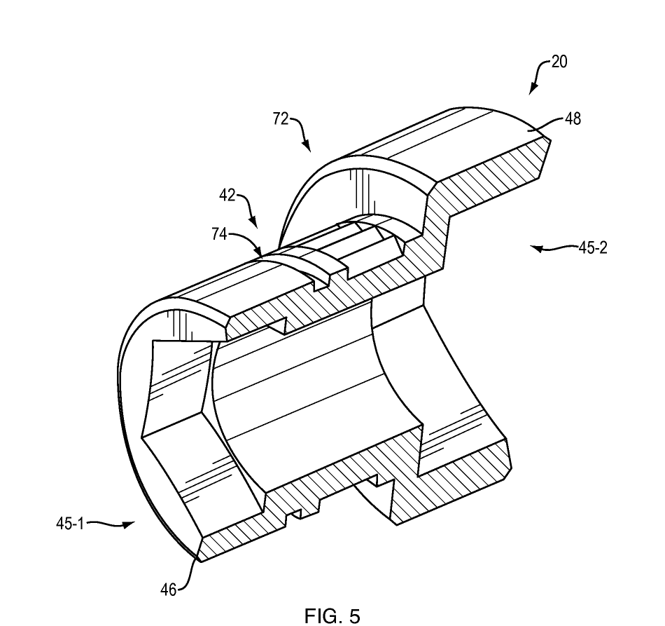

For example, with reference to FIG. 5, the second end 48 of the socket 20 defines a shoulder portion 72 that extends about a circumference of the socket 20. The first end 46 of the socket 20 defines a groove portion 74 that extends about the circumference of the socket 20. With reference to FIG. 6, when the socket 20 is disposed within the socket housing opening of the socket housing 18, the shoulder portion 72 of the socket 20 is disposed in proximity to the second face 66 of the socket housing 18 and the groove portion 74 of the socket 20 is disposed in proximity to the first face 64 of the socket housing 20. The fastener 70 inserts within the groove portion 74 of the socket 20 such that the fastener 70 and the shoulder portion 72 of the socket 20 captures the socket housing 18 there between. The fastener 70 secures the socket 20 to the socket housing 18 and allows the socket 20 to rotate relative to the socket housing 18 and about the longitudinal axis 24.

During operation, with continued reference to FIG. 6, a user can dispose an elongate structure 50, such as a threaded shaft or bolt, within the opening 44 defined by the socket 20. The user can then position the torque wrench assembly 10 along direction 90 until the fastener driving portion 45 engages the fastener 52. The user can then activate the motor assembly 14 of the torque wrench assembly 10 using the switch 34 to rotate the fastener 52 either in a clockwise or counterclockwise direction to position the fastener 52 relative to the elongate structure 50.

The torque wrench assembly 10 can also be configured such that the socket 20 is removeable from the housing 12. Such a configuration allows a user to utilize the torque wrench assembly 10 with different sockets 20 having differently sized fastener driving portions 45 based upon the size of a corresponding fastener 52 to be actuated.

In one arrangement, the socket housing 18 can be removeably attached to the housing 12. For example, with reference to FIG. 2, torque wrench assembly 10 includes a fastener 92 that secures the socket housing 18 to the housing 12. Loosening or removal of the fastener 92 allows the user to separate the socket housing 18 from the housing 12 at interface 94 and replace the socket housing 18 with a second socket housing having a socket 20 with a differently sized fastener driving portion 45. In another arrangement, the socket 20 is configured to be removed from the socket housing 18. For example, the fastener 70, such as the snap ring, can be formed of a relatively flexible material. A user can deform the flexible fastener 70 manually to remove the fastener 70 from the groove portion 74 of the socket 20 and remove the socket 20 from the socket housing 18 and install a socket 20 with a differently sized fastener driving portion 45 in its place.

As indicated in FIGS. 1-3 and 6, the housing 12 is configured as a handle that allows the user to grasp and manipulate the torque wrench assembly 10 during operation. In one arrangement, the torque wrench assembly 10 can include additional handles to enhance grasping and manipulation of the torque wrench assembly 10.

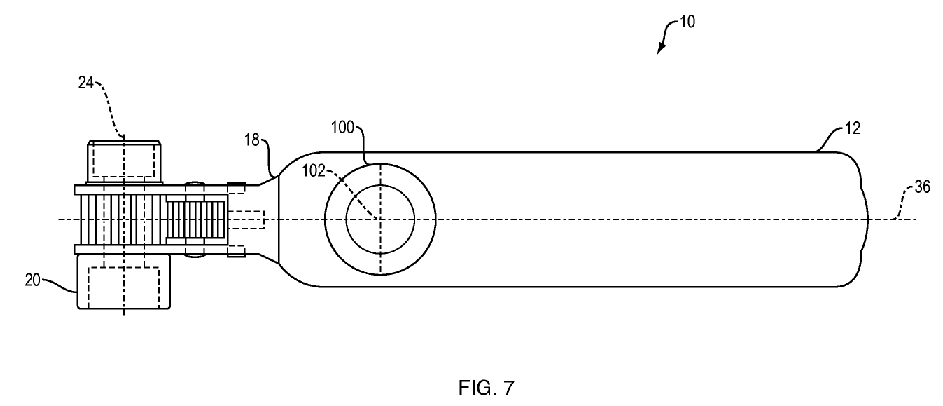

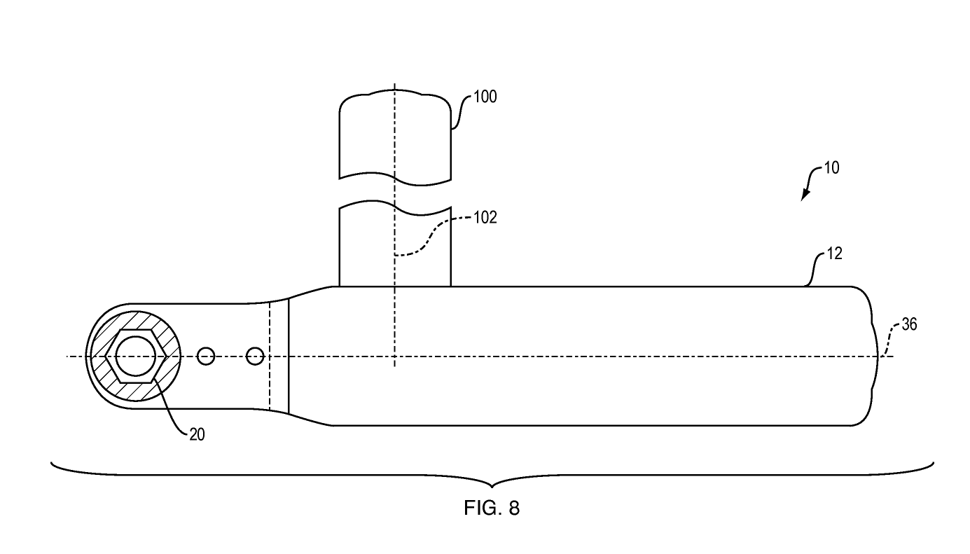

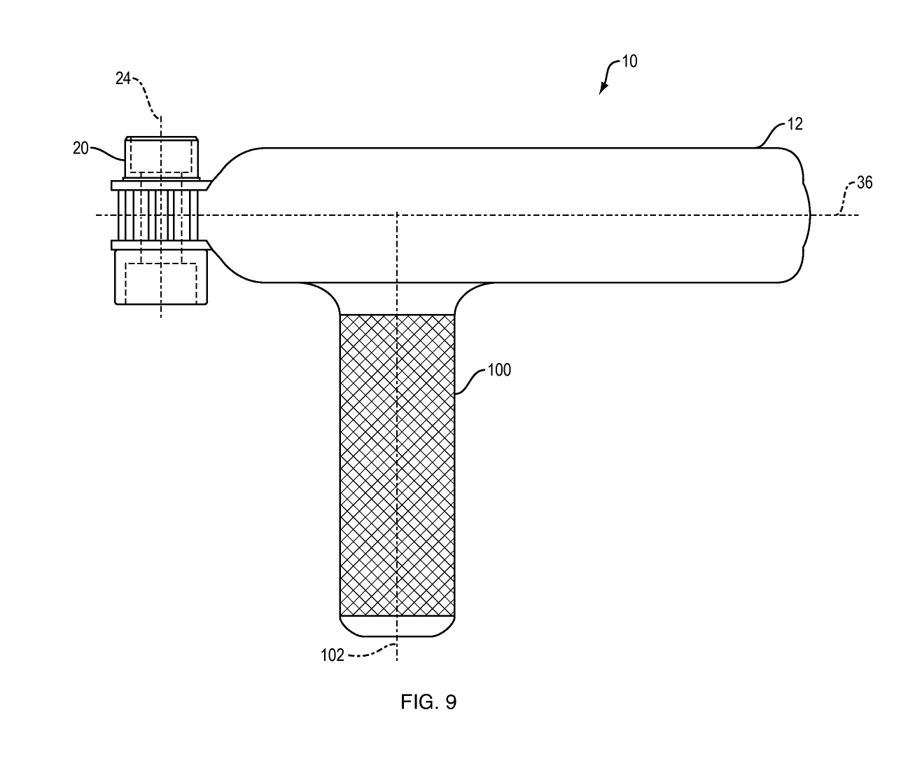

For example, FIGS. 7-9 illustrate the torque wrench assembly 10 having a handle 100 extending from the housing 12 where a longitudinal axis 102 of the handle 100 is substantially perpendicular to a longitudinal axis 36 of the housing. As illustrated, the handle 100 is disposed at a distal end of the housing 12 in proximity to the socket housing 18. Such a configuration allows a user to grasp the torque wrench assembly 10 using two hands (i.e., with one hand on the handle 100 and one hand on the housing 12) to accurately manipulate the torque wrench assembly 10 during operation. As shown, the longitudinal axis of the handle 102 can be oriented either substantially perpendicular to the longitudinal axis 24 of the socket 20 (FIGS. 7 and 8) or substantially parallel to the longitudinal axis 24 of the socket 20 (FIG. 9).

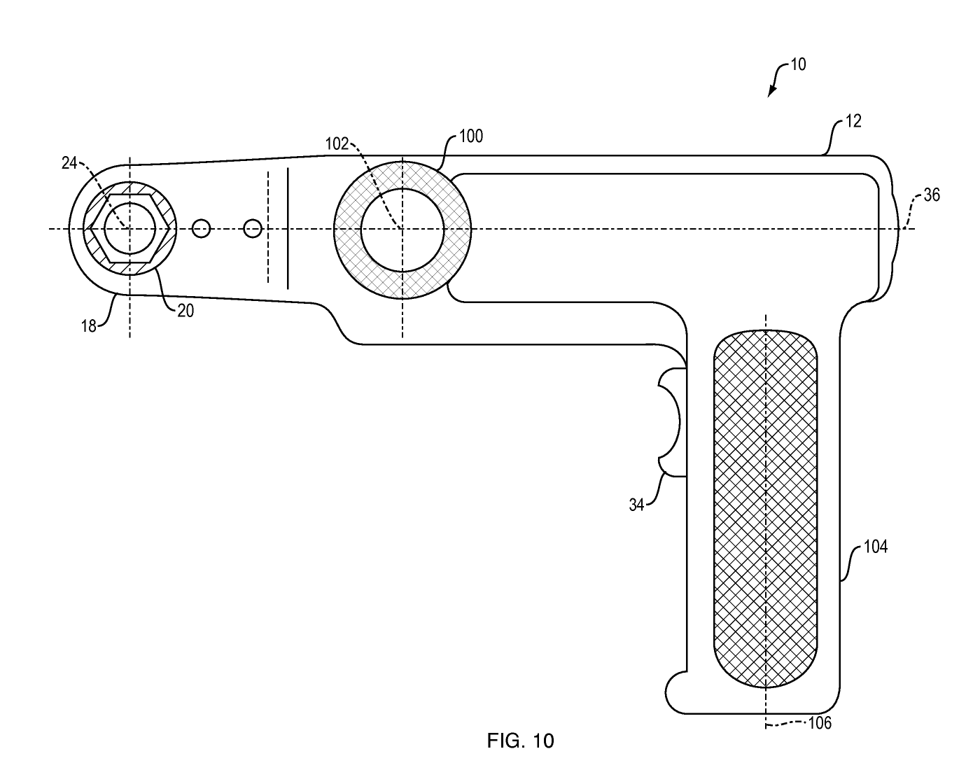

In another arrangement, as illustrated in FIG. 10, the torque wrench assembly 10 includes the first handle 100 disposed at a distal end of the housing 12 in proximity to the socket housing 18 as well as a second handle 104 disposed at a proximal end of the housing 12. Such a configuration allows a user to grasp the torque wrench assembly 10 using two hands (i.e., with one hand on the first handle 100 and one hand on the second handle 104) to accurately manipulate the torque wrench assembly 10 during operation. As shown, the longitudinal axis of the first handle 102 is oriented substantially parallel to the longitudinal axis 24 of the socket 20 while a longitudinal axis 106 of the second handle 104 is oriented substantially perpendicular to the longitudinal axis 24 of the socket 20. However, it should be understood that the longitudinal axis of the first handle 102 can be oriented substantially perpendicular to the longitudinal axis 24 of the socket 20 while the longitudinal axis 106 of the second handle 104 can be oriented substantially parallel to the longitudinal axis 24 of the socket 20.

While various embodiments of the innovation have been particularly shown and described, it will be understood by those skilled in the art that various changes in form and details may be made therein without departing from the spirit and scope of the innovation as defined by the appended claims.

For example, as described above, the fastener driving portions 45-1, 45-2 can be sized to 1- 1/4 Hex and 1- 1/8 Hex, respectively. Such description is by way of example only. In one arrangement, the fastener driving portions 45-1, 45-2 can be configured with a variety of sizes. For example, the fastener driving portions 45-1, 45-2 can be sized to and 1- 1/16 Hex and 15/16 Hex, to 3/4″Hex and 7/8″Hex, and to 15/16″ Hex and 1- 1/16″ Hex, respectively. In another arrangement, the fastener driving portions 45-1, 45-2 can be sized to 17 mm Hex and 19 mm Hex and to 22 mm Hex and 24 mm Hex, respectively.

As indicated above, the torque wrench assembly 10 includes a battery 16 configured to provide power to the motor assembly 14. Such indication is by way of example only. In one arrangement, the torque wrench assembly 10 includes an electrical cord that receives power via an external power source and provides power to the motor assembly 14.

In one arrangement, the geometric and material configuration of the torque wrench assembly 10 allows the torque wrench assembly 10 to generate a relatively large amount of torque on a fastener during operation. For example, the torque wrench assembly 10 is configured to generate a torque between about 50 ft-lb and 150 ft-lb.

As indicated above, during operation, a user activates the motor assembly 14 of the torque wrench assembly 10 to cause the socket 20 to rotate a fastener 52 either in a clockwise or counterclockwise direction to position the fastener 52 relative to a elongate structure 50. In one arrangement, such as where the torque wrench assembly 10 tightens the fastener 52 against a structure, the torque wrench assembly 10 is configured with a torque limiting mechanism to avoid over-tightening the fastener 52. For example, the torque limiting mechanism can reduce the amount of the torque that is generated by the motor assembly 14 during operation. The amount of the reduction is a function of the fastener requirements in the particular application. In one arrangement, the torque limiting mechanism can reduce the amount of the torque that is generated by the motor assembly 14 by between about 25% and 75% of the full torque capability of the assembly.

What is claimed is:

1. A torque wrench assembly, comprising:
a housing having a motor assembly;
a socket defining an opening extending along a longitudinal axis from a first end to a second end and having at least one fastener driving portion disposed at one of the first end and the second end of the socket; and
a socket drive interface coupled to the housing and disposed in operative communication with the motor assembly and with the socket.

2. The torque wrench assembly of claim 1, comprising a socket housing coupled to the housing, the socket and the socket drive interface carried by the socket housing.

3. The torque wrench assembly of claim 2, wherein the socket housing is removeably coupled to the housing.

4. The torque wrench assembly of claim 2, wherein the socket is removeably coupled to the socket housing.

5. The torque wrench assembly of claim 4, wherein:
the first end of the socket defines a shoulder portion extending at least partially about a circumference of the socket, the shoulder portion disposed in proximity to a first face of the socket housing;
the second end of the socket defines a groove portion extending at least partially about a circumference of the socket the groove portion disposed in proximity to a second face of the socket housing; and
a fastener configured to couple with the groove portion, the shoulder portion of the socket and the fastener configured to capture the socket housing therebetween.

6. The torque wrench assembly of claim 1, wherein the at least one fastener driving portion comprises:
a first fastener driving portion disposed at the first end of the socket, the first fastener driving portion configured to drive a fastener having a first size; and
a second fastener driving portion disposed at the second end of the socket, the second fastener driving portion configured to drive a fastener having a second size, the fastener having the second size being distinct from the fastener having the first size.

7. The torque wrench assembly of claim 1, wherein the socket drive interface comprises a gear element configured to rotate the socket about the longitudinal axis in response to rotation of a rotor of the motor assembly.

8. The torque wrench assembly of claim 7, wherein the socket comprises a set of teeth configured to mesh with the gear element, the set of teeth configured as external teeth wherein a root diameter of the external teeth is greater than a diameter of the socket.

9. The torque wrench assembly of claim 7, wherein the socket comprises a set of teeth configured to mesh with the gear element, the set of teeth configured as internal teeth wherein a root diameter of the internal teeth is less than or equal to a diameter of the socket.

10. The torque wrench assembly of claim 1, further comprising a battery disposed in electrical communication with the motor assembly.

11. The torque wrench assembly of claim 1, further comprising at least one handle extending from the housing, a longitudinal axis of the at least one handle being substantially perpendicular to a longitudinal axis of the housing.

12. A torque wrench assembly, comprising:
a housing having a motor assembly and a battery disposed in electrical communication with the motor assembly; and
a socket housing coupled to the housing, the socket housing comprising:
a socket coupled to the socket housing, the socket defining an opening extending along a longitudinal axis from a first end to a second end and having at least one fastener driving portion disposed at one of the first end and the second end of the socket, and
a socket drive interface coupled to the socket housing, the socket drive interface disposed in operative communication with the motor assembly and with the socket.

13. The torque wrench assembly of claim 12, wherein the socket housing is removeably coupled to the housing.

14. The torque wrench assembly of claim 12, wherein the socket is removeably coupled to the socket housing.

15. The torque wrench assembly of claim 14, wherein:
the first end of the socket defines a shoulder portion extending at least partially about a circumference of the socket, the shoulder portion disposed in proximity to a first face of the socket housing;
the second end of the socket defines a groove portion extending at least partially about a circumference of the socket the groove portion disposed in proximity to a second face of the socket housing; and
a fastener configured to couple with the groove portion, the shoulder portion of the socket and the fastener configured to capture the socket housing therebetween.

16. The torque wrench assembly of claim 12, wherein the at least one fastener driving portion comprises:
a first fastener driving portion disposed at the first end of the socket, the first fastener driving portion configured to drive a fastener having a first size; and
a second fastener driving portion disposed at the second end of the socket, the second fastener driving portion configured to drive a fastener having a second size, the fastener having the second size being distinct from the fastener having the first size.

17. The torque wrench assembly of claim 12, wherein the socket drive interface comprises a gear element configured to rotate the socket about the longitudinal axis in response to rotation of a rotor of the motor assembly.

18. The torque wrench assembly of claim 17, wherein the socket comprises a set of teeth configured to mesh with the gear element, the set of teeth configured as external teeth wherein a root diameter of the external teeth is greater than a diameter of the socket.

19. The torque wrench assembly of claim 17, wherein the socket comprises a set of teeth configured to mesh with the gear element, the set of teeth configured as internal teeth wherein a root diameter of the internal teeth is less than or equal to a diameter of the socket.

20. The torque wrench assembly of claim 12, further comprising at least one handle extending from the housing, a longitudinal axis of the at least one handle being substantially perpendicular to a longitudinal axis of the housing.
